(19) United States
(12) Patent Application Publication
(10) Pub. No.: US 2024/0020780 A1
(43) Pub. Date: Jan. 18, 2024

(54) EDUCATION MANAGEMENT METHOD AND SYSTEM

(71) Applicant: Mariana Godinez, Miami, FL (US)

(72) Inventor: Mariana Godinez, Miami, FL (US)

(21) Appl. No.: 18/477,282

(22) Filed: Sep. 28, 2023

Related U.S. Application Data
(63) Continuation-in-part of application No. 16/992,207, filed on Aug. 13, 2020, now abandoned.

(51) Int. Cl. G06Q 50/20; G06Q 40/12

(52) U.S. Cl. CPC G06Q 50/205; G06Q 40/123

(57) ABSTRACT

The method for education management comprises creating a business entity for providing educational services to children of employees of a company, wherein the business entity occupies a commercial space that is owned or leased by the company and provides educational services to the children of the employees within the commercial space, storing internal data values in a connected database, and executing a program configured for reading external data values from third party data providers, reading the internal data values from the connected database, calculating a total monthly cost of base educational services (CBSₘ) and fair market value (Rₘ) for monthly rent for the commercial space and invoicing the company for said educational services, wherein an amount of said invoice is reduced by Rₘ, wherein the monthly tuition charge per child for the educational services (T_{pc}) is based on the formula: T_{pc}=a CBSₘ−b Rₘ/Total_{c}+P

### CROSS-REFERENCE TO RELATED APPLICATIONS

This patent application is a continuation in part of patent application Ser. No. 16/992,207 filed Aug. 13, 2020 and title “Education Management Method and System.” The subject matter of patent application Ser. No. 16/992,207 is hereby incorporated by reference in its entirety.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The claimed embodiments relate to education management, and more specifically, to the field of systems and methods for management of child education.

### BACKGROUND

The concept of providing daycare services and/or child education services within a close distance of one's employment is one that includes multiple benefits for the employees, employers, and the overall working environment. For example, banks and investment groups that provide on-site childcare programs for employees have experienced a return of investment of over 100% due to the inherent benefits of providing these services for their employees. These inherent benefits for the employees include increased loyalty of employees to their employer, improved employee morale, additional bonding time with children, and many other benefits. For example, on-site childcare and/or child education services allow employees to spend more time with their children during the work week, improve concentration on the job, and reduce anxieties associated with parental duties. Certain issues that were historically associated with returning to work after maternity and/or paternity leave have been eliminated or reduced due to the integration of on-site childcare and/or child education services. For example, many parents to newborns worry about returning from maternity and/or paternity leave too soon and missing out on intimate moments with their infant such as breastfeeding, bonding time, the child's first steps, etc. All of the aforementioned are circumvented by having one's child in a safe and secure environment within a close proximity to the parent's work environment.

In addition, employers reap benefits aside from a high return of investment by integrating on-site childcare and/or child education services. For example, on-site services are directly correlated to lower absenteeism, lower turnover, and reduction of common costs such as hiring and training replacements for new parents. Furthermore, availability of on-site childcare and/or child education services exposes companies to a wider variety of applicants due to the targeting of individuals with a family-first approach to their work/life balance.

However, due to the regulatory requirements, logistics, expenses, and other obstacles associated with integrating on-site childcare programs, many employers are hesitant to integrate these services. For example, employers are hindered by increased insurance premiums, increased exposure to liability, and other issues associated with providing on-site childcare services.

Therefore, there exists a need for improvements to providing an education management method and system for employees covered by the employer that capitalizes on incentives provided with on-site childcare and/or child education services.

### SUMMARY

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for education management is disclosed. The method for education management comprises creating a business entity for providing educational services to children of employees of a company, wherein the business entity: 1) occupies a commercial space that is owned or leased by the company; and 2) provides educational services to the children of the employees within the commercial space; storing, by the business entity, internal data values in a connected database, wherein said internal data values include at least a total number of children (Total_{c}) based on matriculation records; executing, by the business entity, a program on a server communicably coupled with a communications network, the program configured for: 1) reading, via the communications network, external data values from third party data providers, wherein said external data values include at least current labor costs; 2) reading the internal data values from the connected database; 3) calculating a total monthly cost of base educational services (CBSₘ) based on the internal data values and the external data values that were read; 4) calculating fair market value (Rₘ) for monthly rent for the commercial space based on the internal data values and the external data values that were read; 5) calculating a coefficient a, a coefficient b and a monthly profit amount per child (P) based on the internal data values and the external data values that were read; and 6) executing an accounting software package configured for invoicing, by the business entity, the company for said educational services, wherein an amount of said invoice is reduced by Rₘ, wherein the monthly tuition charge per child for the educational services (T_{pc}) is based on the following formula: T_{pc}=a CBSₘ−b Rₘ/Total_{c}+P

To the accomplishment of the above and related objects, the claimed embodiments may take the form illustrated in the accompanying drawings, attention being called to the fact, however, that the drawings are illustrative only, and that changes may be made in the specific construction illustrated and described within the scope of the appended claims. The foregoing and other features and advantages of the claimed embodiments will be apparent from the following more particular description of the preferred embodiments, as illustrated in the accompanying drawings.

### BRIEF DESCRIPTION OF THE DRAWINGS

The accompanying drawings, which are incorporated in and constitute part of this specification, illustrate the claimed embodiments and together with the description, serve to explain the principles of the claimed embodiments. The embodiments illustrated herein are presently preferred, it being understood, however, that the invention is not limited to the precise arrangements and instrumentalities shown, wherein:

FIG. 1A is a general diagram illustrating components of a system for facilitating education management over a communications network, in accordance with one embodiment;

FIG. 1B is a block diagram illustrating the network architecture of a system for facilitating education management over a communications network, in accordance with one embodiment;

FIG. 2 is a block diagram showing the data flow of the process for facilitating education management over a communications network, according to one embodiment;

FIG. 3A is a flow chart depicting the general control flow of a process for facilitating education management over a communications network, according to one embodiment;

FIG. 3B is a flow chart depicting the control flow of a calculation sub-process of the process for facilitating education management over a communications network, according to one embodiment;

FIG. 3C is an exemplary diagram illustrating a set of equations associated with a system and method for education management, in accordance with one embodiment; and

FIG. 4 is a block diagram depicting a system including an example computing device and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system and method for education management configured to create a business entity that provides educational services to children of employees of a company on-site or substantially near the workplace associated with the company. The system and method provide a plurality of benefits to the employees by facilitating safe and reliable educational services to the children of employees resulting in an increased amount of time and bonding between parents and their children caused by the shared commute and enhanced interactions, a reduction in parental-related anxieties caused by traditional childcare concerns and associated costs, and an increased amount of employee loyalty to the company based upon on the company being cognizant of their employees' familial concerns relating to the supervision and education of the employees' children. In addition, the system and method provide a plurality of benefits to the employer such as tax benefits, increased employee productivity, and a lower turnover rate in exchange for the employer furnishing the business entity with the operating space for administering educational services. Further, the claimed embodiments provide a monetary benefit to the company or the person paying for the educational services in that tuition is reduced according to the fair market value of the rent/lease/mortgage of the commercial space being used for the educational services.

The method for educational management includes the provision of educational services from a business entity to a company. A company is a legal entity representing an association of people with a specific business objective, such as a bank that provides banking services to the public or a public utility that provides utility services to the public. Company members, i.e., employees, share a common purpose and unite to achieve specific, declared goals. Companies include voluntary associations, which may include nonprofit organizations, business entities, whose aim is generating profit, financial entities, banks, programs and educational organizations. A business entity is an entity that is formed and administered as per corporate law, and may take many forms such as corporations, cooperatives, partnerships, sole traders, limited liability companies and other specifically permitted and labelled types of entities.

It is to be understood that the business entity referred to throughout the disclosure is a third-party entity separate from the company (also hereinafter referred to as “employer”) and the employer's employees. That is, the business entity is an entity separate and distinct from the company. In one embodiment, the business entity is an education management business entity configured to provide educational services to the children of the employees at a location associated with the employer, such as a commercial space or any other area configured to be rented for commercial purposes for taking care of and/or educating children during normal working hours. In one embodiment, the business entity is configured to provide educational services during extended hours outside of normal business hours (extended care or weekend care). It is to be understood that the business entity referred to throughout the disclosure is a third-party entity that provides educational services to the company (or its employees) in exchange for pay or profit. In this relationship, the business entity benefits from gaining income and profits, and the company benefits from receiving educational services at a lower rate and in close proximity, as explained more fully below.

Childcare, otherwise known as day care, is the care and supervision of a child or multiple children at a time, whose ages range from six weeks to thirteen years. Childcare is the action or skill of looking after children by a day-care center, nannies, babysitters, teachers or other providers. Childcare is a broad topic that covers a wide spectrum of professionals, institutions, contexts, activities, and social and cultural conventions.

In one embodiment, the business entity utilizes an accounting package or accounting software for managing the financial aspects of running an educational services business. An accounting package or accounting software is a computer program that maintains account books on computers, including recording transactions and account balances. An accounting package or accounting software can manage budgets, perform accounting tasks, create and send invoices, keep track of payments, manage account payable, manage accounts receivable, manage billing, perform payroll and customer relationship management, and prepare financial reporting. An accounting package or accounting software can further include a general ledger that serves as the company's “books,” a billing module where invoices to clients or customers are produced, stock or inventory control for managing purchase orders for inventory and sales orders for the supply of inventory, bookkeeping where the company records both collection and payment, financial close management where accounting teams verify and adjust account balances at the end of a designated time period, debt collection that tracks attempts to collect overdue bills and may sometimes be part of accounts receivable, an expense module for electronic payment processing and employee business-related expenses. payroll that tracks salary, wages, and related taxes, purchase requisition where requests for purchase orders are made, approved, and tracked, reconciliation that compares records from both sides of transactions for consistency.

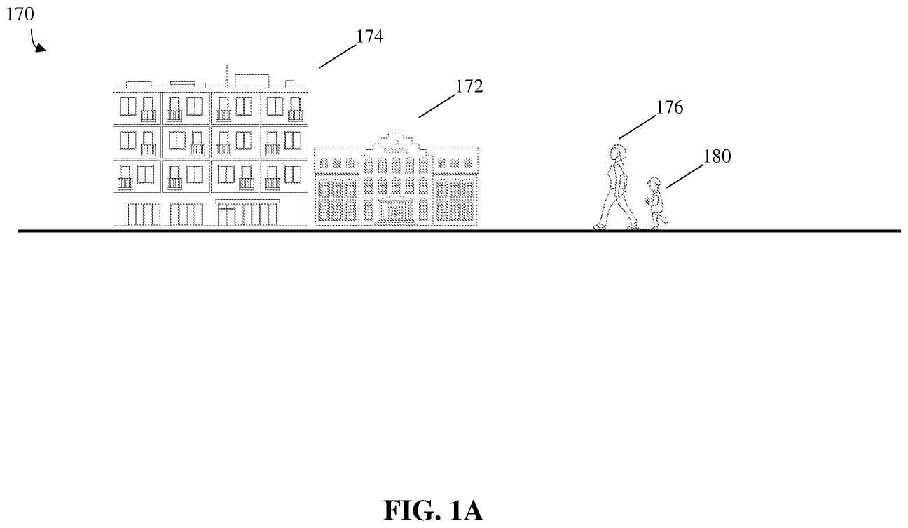

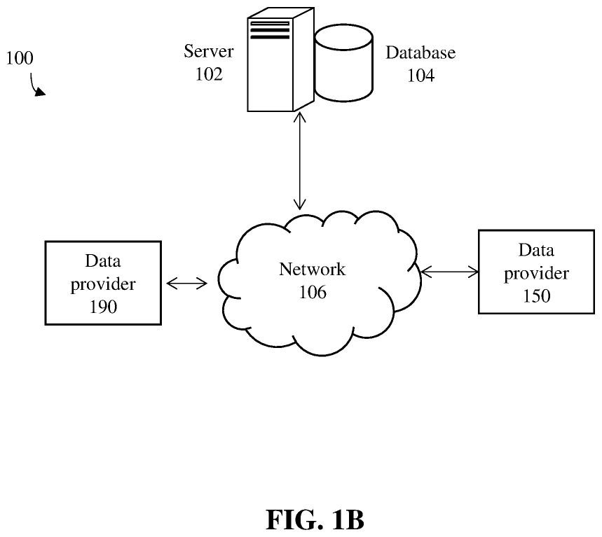

Referring now to FIG. 1A, a method and system for educational management includes a business entity that is created for providing educational services to children of employees of a corporation, such as childcare and preschool through eighth grade classroom instruction. In one embodiment, the educational services may be provided via a virtual learning experience configured to host interactive teaching sessions for the children of the employees. In one embodiment, the virtual learning experience may be used as simply an education assistance mechanism in the location configured to keep the children of the employees engaged within the location. A virtual learning experience comprises instruction and educational services that are provided to a child via video conference, the use of video lessons, and the like.

In one embodiment, the educational services comprises services provided to one or more of the following classes of students: preschool (0-5 years old), prekindergarten (4-5 years old), kindergarten (5-6 years old), primary school (6-11 years old, or first through fifth grade), and secondary school (11-14 years old, or sixth through eighth grade).

The business entity occupies a commercial space (hereinafter referred to as “the location”) configured to be owned, rented or leased by the employer. As shown in FIG. 1A, the location 172 may be in the same commercial space 174 used by the company to house its employees or may be substantially proximate to the commercial space 174 used by the company to house its employees. In said embodiment, an employee 176 of the company can quickly and easily transport his or her child 180 to and from the location 172 before, during or after the employee engages in work at the commercial space 174 used by the company.

In one embodiment, the location 172 is a learning environment configured to comprise a plurality of academic components, a plurality of extra-curricular components, and a plurality of nutritional substance components in which the learning environment is suitable for children of all ages. Examples of the plurality of academic components include but are not limited to valid certifications of all educational professionals operating in the location, a diversity of intelligence curriculum configured to be distributed to the children, an emotional awareness curriculum, a parental schooling program, a juvenile hygiene program, a caregiving station for non-emergency pediatric needs, and any other applicable mechanisms associated with educational management. Examples of the plurality of extracurricular activities include but are not limited to yoga, music, dance, art, science, physical education, and any other applicable non-academic activities. Examples of the plurality of nutritional substance components include but are not limited to at least one homemade meal a day, and at least two healthy snacks distributed to the children throughout the day. Additional non-educational services provided at the location may include sports programs, hobby instruction and open area for rest and relaxation.

In one embodiment, the commercial space may be owned, rented, and/or leased by the business entity or the commercial space may be associated with the business entity in which the business entity owns, rents, and/or leases the location itself. However, in this embodiment, the employer would be responsible for the mortgage, rent or lease payments. The employer may elect for on-site educational management in which the employer is responsible for the mortgage, rent or lease payments for the commercial that the business entity is operating within.

The business entity provides the aforementioned educational and non-educational services to the children of the employees within the location. It is to be understood that while the children are in the custody of the business entity, the business entity assumes liability of the children until the children are returned to the custody of their parents (the employees). The benefit of the on-site location (the educational services being provided within the same location as the employer's workspace, or a proximate location) is to ensure a seamless commute for an employee in which they may drop off their children at the location prior to or during the beginning of their workday and pick up their children at the end of the workday. In one embodiment, the employee may sign their children out of the location in order to take the one or more children to lunch and sign the child back in so that both the parent and children may finish the remainder of their day. In one embodiment, the system for educational management further comprises an attendance tracking mechanism configured to automatically account for the attendance of the children in addition to tracking of the signing in and signing out of each individual child within the care of the business entity.

The business entity charges the employer and or the parents of the children (i.e., the employees) for the aforementioned educational and non-educational services, wherein said charges are reduced proportional to savings realized by the business entity due to use of the commercial space that is owned or leased by the company, as described more fully below.

There is shown in FIG. 1B an illustration of a block diagram showing the network architecture of a system 100 and method for facilitating education management over a communications network in accordance with one embodiment. A prominent element of FIG. 1B is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating education management activities between users.

FIG. 1B includes computing device 102, which may be a computer, server, workstation, desktop computer, virtual machine, smart phone, mobile phone, tablet computer, handheld computer, laptop, or the like. Computing device 102 corresponds to a business entity or a company. FIG. 1B also shows a server, computer or mobile computing device 190 corresponding to a data provider, clearinghouse or outlet. FIG. 1B further shows a server, computer or mobile computing device 150 corresponding to a data provider, clearinghouse or outlet. Devices 102, 190, 150 may be communicatively coupled with network 106 in a wired or wireless fashion.

FIG. 1B further shows that server 102 includes a database or repository 104, which may be a relational database comprising a Structured Query Language (SQL) database stored in a SQL server. Devices 102, 190, 150 may also each include their own database. The repository 104 serves data from a database, which is a repository for data used by server 102 and devices 190, 150 during the course of operation of the disclosed embodiments. Database 104 may be distributed over one or more nodes or locations that are connected via network 106. Database 104 may be located remotely from server 102 and is accessible via network 106.

The database 104 may include a user record for each customer or student 176, 180. A user record may include contact/identifying information for the user (name, address, telephone number(s), email address, etc.), information pertaining to educational services associated with the user, contact/identifying information for employers of the user, electronic payment information for the user, information pertaining to the services provided to the user, sales transaction data associated with the user, etc. A user record may also include a unique identifier for each user, a residential address for each user, the current location of each user (based on location-based services from the user's mobile computer) and a description of past services purchased by each user. A user record may further include demographic data for each user, such as age, sex, income data, race, color, marital status, etc. A user record may also include contact information (email address, name, address, telephone number, etc.) or a unique identifier for one or more family members of the user.

Sales transaction data may include one or more service identifiers, one or more service amounts, buyer contact/identifying information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

FIG. 1B shows an embodiment wherein networked computing devices 190, 150 interact with server 102 and repository 104 over the network 106. It should be noted that although FIG. 1B shows only the networked computers 190, 150 and 102, the system of the disclosed embodiments supports any number of networked computing devices connected via network 106. Further, server 102, and units 190, 150 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 190, 150. Further, server 102 and its functionality, according to a preferred embodiment, can be realized in a centralized fashion in one computer system or in a distributed fashion wherein different elements are spread across several interconnected computer systems.

FIG. 1 also shows data providers 190, 150, which represents the physical presence of an organization or business that provides data, such as the U.S. Bureau of Labor Statistics, which publishes average U.S. employer costs for employee compensation (i.e., current labor costs), the consumer price index (CPI), and the current U.S. inflation rate, or the Federal Reserve Bank of New York, which publishes the federal funds rate. The data providers 190, 150 may be any organization that provides business information over the network 106 to third parties. The data providers 190, 150 may also represent the information technology infrastructure, including servers and computers, which are used by the providers to provide said data.

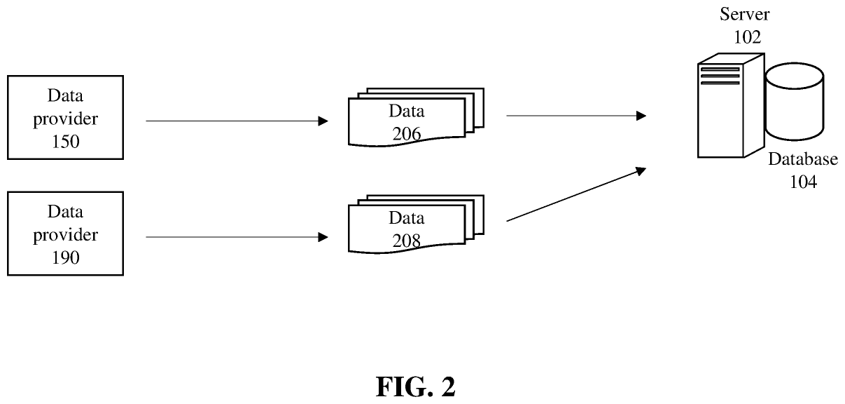

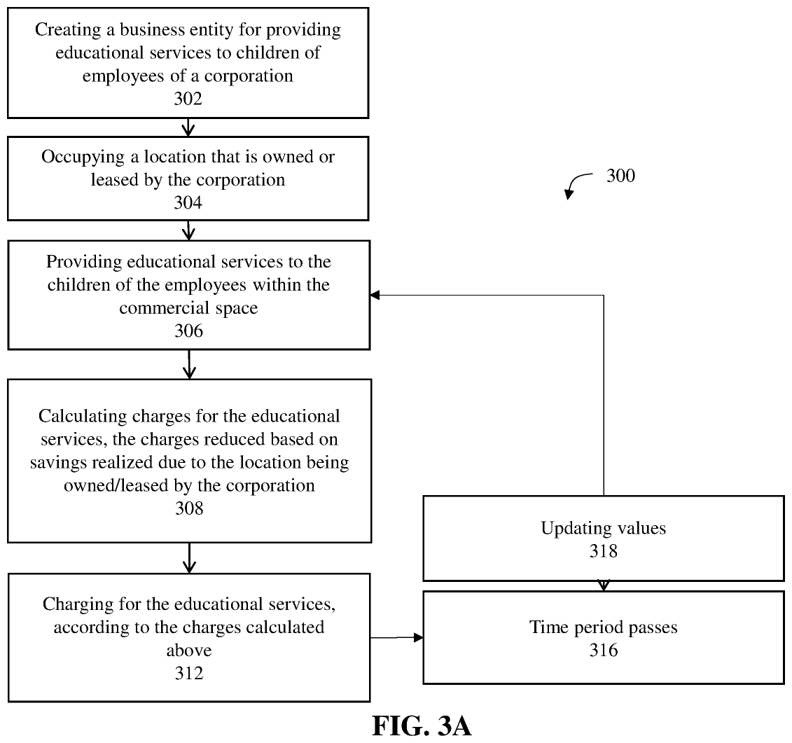

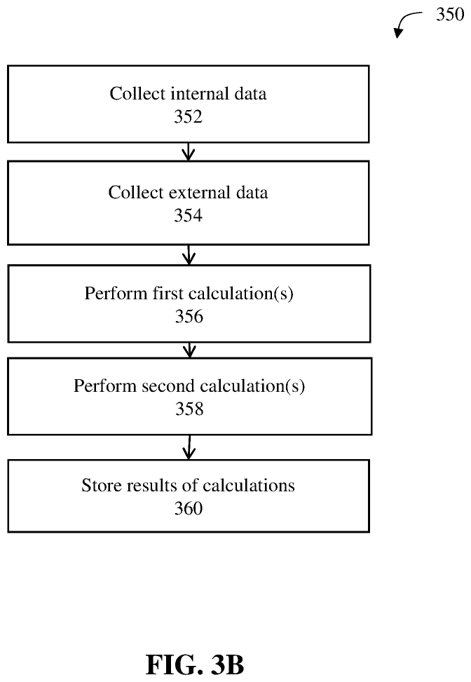

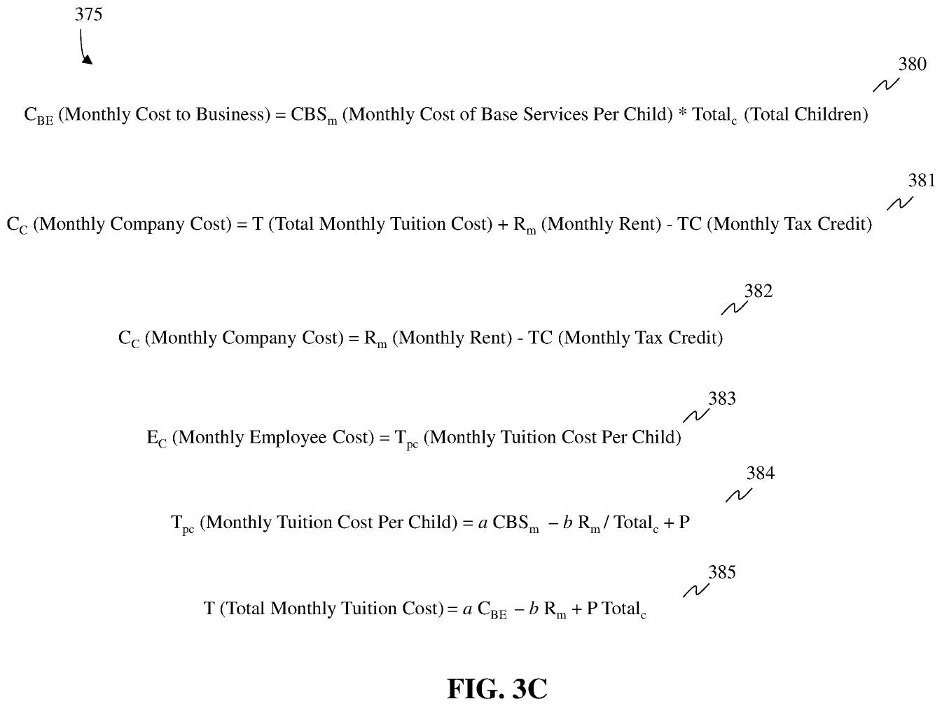

The process of education management over a communications network will now be described with reference to FIGS. 2-3C below. FIG. 2 is a block diagram showing the data flow of the process for facilitating education management over a communications network, while FIG. 3A is a flow chart depicting the general control flow of a process for facilitating education management over a communications network. The process 300 for facilitating education management over a communications network begins with step 302 wherein a business entity is formed for providing educational services to children of employees of the company. In one example, this step comprises incorporating a corporation with a local division of corporations, creating business accounts with local banks and hiring staff and employees. Next, in step 304, a location 172 that is owned or leased by the company is occupied by the business entity. In one example, this step comprises having the staff and employees inhabit the location, set up desks and working materials and setting up communications, such as Internet and telephone services.

Then, in step 306, the business entity begins offering its educational services to the employees of the company at the location 172 that is owned or leased by the company. In one example, this step comprises having the staff and employees provide education to the children of the employees in the form of childcare and preschool through eighth grade classroom instruction. In step 308, the business entity calculates the charges or tuition for the educational services that are being provided to the employees, wherein those charges are reduced by the savings realized due to the fair market value of the location 172 that is owned or leased by the company. This step 308, which is described in greater detail below with reference to FIG. 3B, may be performed by one or more programs executing on server 102.

In step 312, the charges or tuition for the educational services that was calculated above is charged, billed or invoiced to the paying party, whether it is the company, the employee or a combination of the two. Step 312 may be performed by one or more programs executing on server 102. Later in that same step, the paying party pays the business entity what it was charged, billed or invoiced. In step 312, an accounting package of the business entity bills or invoices the paying party for the charges or tuition for the educational services that was calculated above. Said bill or invoice may be sent electronically (via messaging, email or via an accounting software) to the paying party.

In step 316, a set or predefined time period used for issuing bills or invoices, such as one month or another commercially reasonable time period, passes. This passage of time may be monitored and measured by one or more programs executing on server 102. In step 318, certain values of internal data or external data that were used in the calculations of step 308 are updated by one or more programs executing on server 102. Of the internal and external data that was used in step 308, some values may change over time, such as economic conditions and price competition. In step 318, certain values of internal data that have changed since the last execution of step 308 are updated. This may include, for example, operational costs associated with running the business, such as labor costs and material costs. For example, if the business entity experiences changes in operational costs, such as increased salaries for educational staff or higher utility bills, an adjustment to certain internal data could be warranted to maintain financial stability. By periodically updating certain internal data as conditions change over time, the business entity can ensure that it continues to meet its financial goals while also providing value to both the employer and the employees using the service. In this case, the server 102 updates values of said internal data in database 104. In step 318, certain values of external data that have changed since the last execution of step 308 are updated. This may include, for example, current U.S. market conditions and the current U.S. inflation rate. In this case, the data providers 150, 190 update the values of said external data.

In one embodiment, certain values of internal data that were used in the calculations of step 308 are updated in step 318 by one or more programs executing on server 102 based on the external data values that were read in step 354. In this embodiment, the updated internal data values are dependent on the external data values that were read in step 354. For example, current labor costs are external data that may be read from a third-party data provider 150, such as the U.S. Bureau of Labor Statistics. Said external labor cost data is read in step 354 and when it comes time to update internal data values in step 318, said internal data values that depend in current labor costs, such as current operational costs, are updated based on the current labor cost data that was read. In short, internal data may be dependent on external data.

FIG. 3B is a flow chart showing more detail about the calculating step 308 of FIG. 3A. The process 350 begins with step 352 wherein internal data values are collected by the server 102, wherein internal data refers to data that is internal to the business entity or the company, such as the total number of children enrolled for the current period, operational costs, profit margin goals, etc. Said internal data values may have already been collected and stored in the database 104 for later reading or collection. Some of said internal data values may have already been collected and stored in the database 104 by the accounting software or package. In that case, the internal data values are collected from the database 104. In step 354, external data values are collected by the server 102, wherein external data refers to data that is external to the business entity or the company, such as market conditions, the inflation rate, etc. Said external data values may have already been collected and stored by data providers 150, 190 for later reading or collection. In that case, the external data values 206, 208 are collected from the data providers 150, 190 over network 106.

In step 356, one or more first calculations are executed. In one embodiment, step 356 comprises calculating the value of CBSₘ (the monthly cost of base services per child), taking into account the internal and external data values that were collected. In one embodiment, calculating the value of CBSₘ includes identifying a subset of the internal and external data values that were collected that are taken into account when calculating the value of CBSₘ. In another embodiment, step 356 comprises calculating the value of C_{BE} (the monthly cost to the business in operating its educational services business) according to formula 380, taking into account the internal and external data values that were collected. In one embodiment, calculating the value of C_{BE} includes identifying a subset of the internal and external data values that were collected that are taken into account when calculating the value of C_{BE}. In another embodiment, step 356 comprises calculating the values of coefficient a, coefficient b and P, taking into account the internal and external data values that were collected. In one embodiment, calculating the values of coefficient a, coefficient b and P includes identifying a subset (separately for each of coefficient a, coefficient b and P) of the internal and external data values that were collected that are taken into account when calculating each value.

In step 358, one or more second calculations are executed. In one embodiment, step 358 comprises calculating the value of T_{pc} (the monthly tuition cost per child) according to formula 384, taking into account the calculations made in step 356 and the internal and external data values that were collected. In another embodiment, step 358 comprises calculating the value of T (the total monthly cost for all children) according to formula 385, taking into account the calculations made in step 356 and the internal and external data values that were collected. In step 360, the results of the calculations of steps 356, 358 are stored in database 104.

Referring now to FIG. 3C, a set of formulae 375 associated with the method of educational management is depicted according to an example embodiment. The set of formulae 375 comprises a first formula 380 representing an exemplary total monthly cost of educational and non-educational services provided by the business entity in the course of providing educational services. The total cost of educational services provided by the business entity is subject to adjustment based on a plurality of factors. For example, first formula 380 may reflect a scenario in which the business entity provides a plurality of investments into the location in exchange for the employer providing or paying for the location (mortgage payments, rent payments, lease payments, for example). Examples of the aforementioned investments include but are not limited to construction/decorum/architectural layout of the location, city permits/licenses and other applicable certification documentation, furniture, fixtures, childproofing, and any other applicable fees and/or tasks associated with the upkeep of the location.

The first formula 380 describes the calculation of the costs to the business entity in operating its business. In application of first formula 380, C_{BE} represents total monthly cost to the business entity of providing educational and non-educational services for all children of employees of the company, CBSₘ represents the monthly cost of base services per child associated with the business entity providing educational and non-educational services, and Total_{c} is a total number of children of employees of the company that are being provided educational services according to matriculation records in database 104. In one example of formula 380, the total monthly cost to the business entity is calculated based on a minimum of 200 children enrolled at a monthly cost of base services per child of $950. Thus, the total monthly cost C_{BE} of educational and non-educational services incurred by the employer is equal to 200×$950=$190,000.

CBSₘ, the monthly cost of base services per child associated with the business entity providing educational and non-educational services, may be calculated in a variety of ways. In one embodiment, the value is calculated by calculating all expenses and costs of the business entity for one month (including electricity, water, sewer, supplies, labor expenses, employment expenses, cost of goods purchased, cost of business licenses, costs of inspections, etc.) and dividing said value by Total_{c}, the total number of children of employees of the company that are being provided educational services. In an alternative embodiment, the first formula 380 may be revised to include a fixed monthly cost value (such as a variable Fₘ) that represents fixed monthly costs that do not vary by number of children being provided services, such as the cost of a business license, the cost of electricity, the labor cost of a principal, etc.). In this alternative embodiment, the variable Fₘ is added to CBSₘ and the value of CBSₘ is limited to those costs that only vary per number of children being provided services, such as water, supplies, labor expenses, employment expenses, cost of goods purchased, etc.

CBSₘ may be affected by a variety of factors, including the quality of educational materials used, such as textbooks and interactive learning tools, could influence the cost. The salaries and benefits of the educational staff, which may vary depending on their qualifications and experience, could also be a significant factor. Operational costs like utilities, maintenance, and insurance for the educational facility would contribute to CBSₘ as well. Labor costs and materials costs are included in operational costs. Technological investments, such as computers or specialized educational software, could add to the cost. Location can also be a factor; operating in a high-rent district would naturally increase CBSₘ. Regulatory compliance, including meeting educational standards and safety guidelines, could necessitate additional expenditures. Special programs or extracurricular activities offered could also affect the value of CBSₘ. Seasonal activities or field trips that require additional funding could be another consideration. Market conditions, including the level of demand for the educational services and the pricing strategies of competitors, could also influence CBSₘ. Of the factors that affect the value of CBSₘ, some may be categorized as internal data (such as operational costs like utilities and maintenance), and some may be categorized as external data (such as market conditions). Said internal data may be stored, maintained and updated in records in database 104.

The second formula 381 describes the calculation of the costs to the company in having a relationship with the business entity in operating its educational business. In application of second formula 381, the company is configured to pay for the location and for the tuition for all of the children of employees. C_{C} (company cost) represents the total monthly cost incurred by the employer accounting for tax incentives and T is a total monthly tuition charge for the educational and non-educational services provided to all children. Rₘ is the monthly rent (or mortgage payment or lease payment or fair market value for the rent or lease payment) for the commercial space. TC is the monthly tax credit provided to the employer by governmental authorities for its childcare and/or educational expenses. In one embodiment, the employer receives a tax credit equal to 25% of childcare facility expenditures in addition to 10% of the qualified childcare resource and referral expenditures paid or incurred during the tax year. Thus, the tax credit provided to the employer if the employer provides or pays for the location (rent/mortgage/lease) could be close to, equal to or proportional to Rₘ, the monthly rent, leaving only T (total monthly tuition charge) to be paid by the employer. In one embodiment, the employer can further deduct a calculated percentage of unrecovered costs from the applicable corporate taxes. Rₘ may be categorized as external data.

Note that as shown with regard to formula 381, the aforementioned system and method for educational management in the preferred embodiment not only ensures that the employer receives a yearly tax credit, but also a reduction in tuition, as shown below with regard to the formula for calculating tuition charges. It is important to consider that the amount that is saved is attributed to multiple factors; in particular; the aforementioned preferred embodiment is supplemented by a significant amount of investment by the business entity into the location of the commercial space and a lack of assumption of the lease, rent or mortgage payments for the location.

The third formula 382 describes an alternative calculation of the costs to the company in having a relationship with the business entity in operating its educational business. In application of third formula 382, the company is configured to pay for the location but not for the tuition for the children of employees (unlike second formula 381). In this case, each employee pays for the tuition for each child. C_{C} (company cost) represents the total monthly cost incurred by the employer accounting for tax incentives. Rₘ is the monthly rent (or mortgage payment or lease payment or fair market value for the rent or lease payment) for the commercial space. TC is the monthly tax credit provided to the employer by governmental authorities for its childcare and/or educational expenses. In one embodiment, the employer receives a tax credit equal to 25% of childcare facility expenditures in addition to 10% of the qualified childcare resource and referral expenditures paid or incurred during the tax year. In one embodiment, the employer can further deduct a calculated percentage of unrecovered costs from the applicable corporate taxes.

In a preferred embodiment, the system and method of educational management is designed and configured to deduct less than or equal to 35% of unrecovered costs from a corporate tax associated with the employer. It is to be understood that the system and method of educational management is configured to be established in a manner that does not require any investment on behalf of the employer besides the location or commercial space. The ultimate goal of the system and method is to provide a secure foundation for child education via an on-site location within a professional's workplace in order to simultaneously provide the on-site education management for the professional's offspring in addition to increase productivity and work-life balance within the professional's workspace.

The fourth formula 383 describes a calculation of the costs to each employee using the business entity as an educational provider for his or her children. Fourth formula 383 assumes that the employer is not covering cost of the educational services provided by the business entity assumes. In this example, the monthly employee cost (E_{C}) is equal to the monthly tuition cost of educational services rendered by the business entity.

The fifth formula 384 describes a calculation of the total monthly tuition costs for each child. Fifth formula 384 shows how the business entity charges the company or the employee (parent of the child being educated) a monthly tuition charge per child for the educational services it provides, wherein T_{pc} is a total monthly tuition charge per child for the educational services:

T_{pc}=aCBSₘ−bRₘ/Total_{c}+P
wherein T_{pc} is a total monthly tuition charge per child for the educational services, CBSₘ is a total monthly cost of base educational services per child, Rₘ is fair market value for monthly rent for the commercial space, P is a monthly profit amount per child, Total_{c} is a total number of children being provided educational services, a is a coefficient real number and b is a coefficient real number. In one embodiment, a is within a range of 0<a<1 and b is within a range of 0<b<1. In that case, the purpose of the coefficients is to reduce the multiplicand. In another embodiment, a is within a range of 1<a and b is within a range of 1<b. In that case, the purpose of the coefficients is to increase the multiplicand. Consequently, the purpose of the coefficients is to act as a multiplier of the multiplicand, so as to account for externalities that affect the multiplicand.

Note that the calculation of T_{pc} is reduced by Rₘ, the fair market value for monthly rent for the commercial space, which is a large benefit for the person paying for tuition, which is either the company or the company employee. That is, one of the advantages of the claimed embodiments is that the tuition being paid for educational services is reduced by the amount of the fair market value for monthly rent for the commercial space, so that the company (or its employees) get the benefit of providing its commercial space to the company. This is an inventive step that is an advancement in the area of educational services.

Returning to the fifth formula 384, the coefficient a may be adjusted to vary the degree to which the total monthly cost of base educational services per child (CBSₘ) is being charged to the employer or employee. Put another way, the coefficient a may be adjusted to vary the degree to which the total monthly cost of base educational services per child (CBSₘ) is taken into account when calculating T_{pc} for a particular child. In a situation where the employee of the child being provided services has a lower income, the business entity may decide to charge the employee less than the total monthly cost of base educational services per child (CBSₘ), in which case the business entity may decide to use a value of a that is less than 1, such as 0.5 or 0.6. In a situation where the employee of the child being provided services has a higher income, the business entity may decide to charge the employee close to or equal to the total monthly cost of base educational services per child (CBSₘ), in which case the business entity may decide to use a value of a that is closer to 1, such as 0.9 or 1.0.

The coefficient a may also be adjusted according to economic factors such as the current rate of inflation and the local cost of living. A higher inflation rate might necessitate a higher coefficient to cover increased costs, and in areas where the cost of living is high, the coefficient might be adjusted upwards. A higher consumer price index (CPI) might necessitate a higher coefficient to cover increased prices, and vice versa. The coefficient a may also be adjusted according to business factors such as operational costs and profit margin goals of the business entity. If the business faces higher operational costs or has specific profit margin goals, the coefficient might be increased. Competitive pricing is another consideration, and the coefficient could be adjusted based on what competitors are charging for similar services. The coefficient a may also be adjusted according to social factors such as employee tenure and the number of children an employee has. Long-term employees might be offered a lower coefficient as a loyalty benefit, and those with more children might get a discount. The coefficient a may also be adjusted according to quality-of-service factors. If the services are of a high standard or if additional services like extracurricular activities are offered, the coefficient might be adjusted upwards. The coefficient a may also be adjusted according to governmental and legal factors such as tax benefits, subsidies, or regulatory requirements. For example, if the business entity receives tax benefits or subsidies, the coefficient could be lowered. Seasonal demand is another factor that could lead to a temporary increase in the coefficient during high-demand seasons or a temporary decrease in the coefficient during low-demand seasons. Of the factors that affect the value of a, some may be categorized as internal data (such as Total_{c}, operational costs like utilities and maintenance and profit margin goals) and some may be categorized as external data (such as the inflation rate, CPI and market conditions). Said internal data may be stored, maintained and updated in records in database 104.

In one embodiment, the coefficient a is calculated based on the factors (internal and external data values) described above as follows. Each factor being considered is assigned a weight that is a real number. The weight assigned to a factor is based on the possible numerical range of the factor, the importance of said factor in deciding the ultimate value of the coefficient, and the amount the coefficient should affect the multiplicand. The greater the numerical range of the factor, the lower the weight, the greater the importance of the factor, the greater the weight, and the greater the amount the coefficient should affect the multiplicand, the greater the weight. After weights are assigned to each factor, the value of each factor is multiplied by its corresponding weight, producing a product for each factor. Finally, the sum of all products of all factors being considered is calculated, thereby producing the coefficient a. In one example, the two factors being considered are the inflation rate and the CPI, wherein inflation has a weight of 25 and the CPI has a weight of 0.002. In the example, the value of the inflation rate is 3%, and the value of the CPI is 304. The inflation rate of 0.03 is multiplied by its weight of 25, yielding 0.75, and the CPI of 304 is multiplied by its weight of 0.002, yielding 0.608. The sum of 0.75 and 0.608 results in coefficient a=1.358.

The coefficient b may also be adjusted to vary the degree to which the fair market value for monthly rent for the commercial space is being deducted from the amount being charged to the employer or employee. Put another way, the coefficient b may be adjusted to vary the degree to which the fair market value for monthly rent is taken into account when calculating T_{pc} for a particular child. In a situation where the employee of the child being provided services has a lower income, the business entity may decide to allow the employee the full (or close to full) benefit of having the company pay for the rent/mortgage/lease for the space, and the business entity may decide to use a value of b that is closer to 1, such as 0.9 or 1.0. In a situation where the employee of the child being provided services has a higher income, the business entity may decide to allow the employee less than the full benefit of having the company pay for the rent/mortgage/lease for the space, and the business entity may decide to use a value of b that is less than 1, such as 0.2 or 0.3.

The coefficient b may also be adjusted according to lease/rent/mortgage terms. If the lease/rent/mortgage terms for the commercial space are particularly favorable or unfavorable, b could be adjusted accordingly, i.e., higher for less favorable terms and vice versa. The coefficient b may also be adjusted according to space utilization. The extent to which the commercial space is used for educational services versus other activities could affect the coefficient, i.e., higher for more usage and vice versa. The coefficient b may also be adjusted according to location. If the commercial space is in a high-rent district, b might be adjusted upwards to account for the higher costs, and vice versa. The coefficient b may also be adjusted according to facility quality. The quality and amenities of the commercial space could influence the coefficient, with higher-quality spaces possibly leading to a higher coefficient, and vice versa. The coefficient b may also be adjusted according to economic conditions. In a recession, b might be lowered to make the services more affordable, while in a booming economy, it might be raised. The coefficient b may also be adjusted according to company contributions. If the company contributes to maintenance or utilities, b could be adjusted downwards and vice versa. The coefficient b may also be adjusted according to market competition. The pricing strategies of competitors offering similar services could influence the adjustment of the coefficient, with high price competition possibly leading to a higher coefficient, and vice versa. The coefficient b may also be adjusted according to operational costs. If the business entity has to invest significantly in adapting or maintaining the space, b might be increased and vice versa. Of the factors that affect the value of b, some may be categorized as internal data (such as facility quality and company contributions), and some may be categorized as external data (such as the economic conditions and price competition). Said internal data may be stored, maintained and updated in records in database 104.

In one embodiment, the coefficient b is calculated based on the factors (internal and external data values) described above in the same manner in which the coefficient a is calculated.

P, the monthly profit amount per child, may be adjusted over time to account for changes in the economy, changes in the consumer price index, changes in inflation, changes in the cost of services, and changes in the amount consumers are willing to pay for educational and non-educational services. Additional factors that could influence the adjustment of P include market demand for the educational services offered. Higher demand could justify a higher P value. Seasonal variations could also play a role; for example, P might be increased during peak enrollment seasons and decreased during off-peak times. The quality and range of educational services provided could also impact P. If specialized or high-quality services are offered, a higher P might be set to reflect the added value. Operational efficiencies or inefficiencies could also affect P. If the business entity is able to reduce operational costs through efficiencies, P could potentially be lowered, benefiting consumers. Conversely, unexpected operational costs might necessitate a higher P. Regulatory changes, such as new educational standards or labor laws, could also lead to adjustments in P to cover compliance costs. Finally, competitive landscape factors, such as the entry of a new competitor or the exit of an existing one, could necessitate adjustments to P to either capture more market share or maintain current levels. These are just some considerations, and the actual factors can vary based on the specific circumstances of the business entity. Of the factors that affect the value of P, some may be categorized as internal data (such as operational costs), and some may be categorized as external data (such as competitive landscape factors). Said internal data may be stored, maintained and updated in records in database 104.

In one embodiment, P is calculated based on the factors (internal and external data values) described above in the same manner in which the coefficients a and b are calculated.

The sixth formula 385 describes a calculation of the total monthly tuition cost for all children. Sixth formula 385 shows how the business entity charges the company a monthly tuition charge for all children for the educational services it provides, wherein T is a total monthly tuition charge for all children for the educational services:

T=aC_{BE}−bRₘ+PTotal_{c}
wherein T is a total monthly tuition charge for the educational services for all children, C_{BE} represents total monthly cost to the business entity of providing educational and non-educational services for all children of employees of the company (see formula 380 above), Rₘ is fair market value for monthly rent/lease/mortgage for the commercial space, P is a monthly profit amount per child, Total_{c} is a total number of children being provided educational services, a is a coefficient real number with a range of 0≤a≤1 and b is a coefficient real number with a range of 0≤b≤1. Note that the calculation of T is reduced by Rₘ, the fair market value for monthly rent for the commercial space, which is a large benefit for the person paying for tuition, which is either the company or the company employee.

The coefficient a may be adjusted to vary the degree to which the total monthly cost to the business entity of providing educational and non-educational services for all children of employees of the company (C_{BE}) is being charged to the employer. The coefficient a may be adjusted as described above. The coefficient b may also be adjusted to vary the degree to which the fair market value for monthly rent for the commercial space is being deducted from the amount being charged to the employer. The coefficient b may be adjusted as described above.

P, the monthly profit amount per child, may be adjusted over time to account for a variety of factors, as described above. Note that P is multiplied by the total number of children Total_{c}.

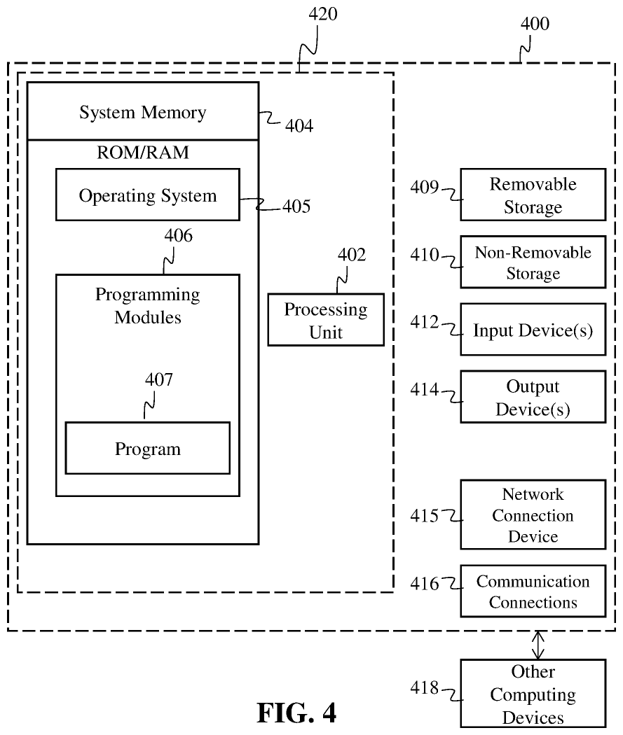

FIG. 4 is a block diagram of a system including an example computing device 400 and other computing devices. Consistent with the embodiments described herein, the aforementioned actions performed by 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for systems 100, 170 and processes 300, 350 as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g., random-access memory (RAM)), non-volatile (e.g., read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g., program module 407) may perform processes including, for example, one or more of the stages of the processes 300, 350 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An education management method comprising the steps of:
creating a business entity for providing educational services to children of employees of a company, wherein the business entity:
1) occupies a commercial space that is owned or leased by the company; and
2) provides educational services to the children of the employees within the commercial space;
storing, by the business entity, internal data values in a connected database, wherein said internal data values include at least a total number of children (Total_{c}) based on matriculation records;
executing, by the business entity, a program on a server communicably coupled with a communications network, the program configured for:
1) reading, via the communications network, external data values from third party data providers, wherein said external data values include at least current labor costs;
2) reading the internal data values from the connected database;
3) calculating a total monthly cost of base educational services (CBSₘ) based on the internal data values and the external data values that were read;
4) calculating fair market value (Rₘ) for monthly rent for the commercial space based on the internal data values and the external data values that were read;
5) calculating a coefficient a, a coefficient b and a monthly profit amount per child (P) based on the internal data values and the external data values that were read; and
6) executing an accounting software package configured for invoicing, by the business entity, the company for said educational services, wherein an amount of said invoice is reduced by Rₘ, wherein the monthly tuition charge per child for the educational services (T_{pc}) is based on the formula:
T_{pc}=aCBSₘ−bRₘ/Total_{c}+P

2. The method of claim 1, wherein said external data values that are read from third party data providers further comprise a current consumer price index (CPI).

3. The method of claim 2, wherein said internal data values that are read from a connected database further comprise a current monthly mortgage, rent or lease payment being paid by the company for the commercial space.

4. The method of claim 3, wherein the step of calculating coefficient a further comprises:
identifying a subset of the internal data values and the external data values that were read that are taken into account in calculating coefficient a;
assigning a weight to each data value of the subset of the internal data values and the external data values;
multiplying each data value of the subset of the internal data values and the external data values by its assigned weight, thereby generating a plurality of products; and
adding all of the plurality of products.

5. The method of claim 4, wherein the step of calculating coefficient b further comprises
identifying a subset of the internal data values and the external data values that were read that are taken into account in calculating coefficient b;
assigning a weight to each data value of the subset of the internal data values and the external data values;
multiplying each data value of the subset of the internal data values and the external data values by its assigned weight, thereby generating a plurality of products; and
adding all of the plurality of products.

6. The method of claim 5, wherein the step of calculating P further comprises:
identifying a subset of the internal data values and the external data values that were read that are taken into account in calculating P;
assigning a weight to each data value of the subset of the internal data values and the external data values;
multiplying each data value of the subset of the internal data values and the external data values by its assigned weight, thereby generating a plurality of products; and
adding all of the plurality of products.

7. The method of claim 6, further comprising:
receiving, by the company, a tax credit proportional to Total_{c} and proportional to Rₘ.

8. The method of claim 7, further comprising:
deducting, by the company, less than or equal to 35% of unrecovered costs associated with said commercial space from a corporate tax associated with the company.

9. The method of claim 8, wherein the educational services comprise daycare and/or preschool through eighth grade instruction.

10. The method of claim 9, the program further configured for:
updating, by the business entity, the internal data values in the connected database based on external data values that have been read over the communications network.

11. An education management method comprising the steps of:
creating a business entity for providing educational services to children of employees of a company, wherein the business entity:
1) occupies a commercial space that is owned or leased by the company; and
2) provides educational services to the children of the employees within the commercial space;
storing, by the business entity, internal data values in a connected database, wherein said internal data values include at least a total number of children (Total_{c}) based on matriculation records;
executing, by the business entity, a program on a server communicably coupled with a communications network, the program configured for:
1) reading, via the communications network, external data values from third party data providers, wherein said external data values include at least current labor costs;
2) reading the internal data values from the connected database;
3) calculating a total monthly cost of base educational services (CBSₘ) based on the internal data values and the external data values that were read;
4) calculating fair market value (Rₘ) for monthly rent for the commercial space based on the internal data values and the external data values that were read;
5) calculating a coefficient a, a coefficient b and a monthly profit amount per child (P) based on the internal data values and the external data values that were read;
6) executing an accounting software package configured for invoicing, by the business entity, the employees of the company for said educational services, wherein an amount of said invoice is reduced by Rₘ, wherein the monthly tuition charge per child for the educational services (T_{pc}) is based on the formula:
T_{pc}=aCBSₘ−bRₘ/Total_{c}+P; and
7) updating, by the business entity, the internal data values in the connected database based on external data values that have been read over the communications network.

12. The method of claim 11, wherein said external data values that are read from third party data providers further comprise a current consumer price index (CPI).

13. The method of claim 12, wherein said internal data values that are read from a connected database further comprise a current monthly mortgage, rent or lease payment being paid by the company for the commercial space.

14. The method of claim 13, wherein the step of calculating coefficient a further comprises:
identifying a subset of the internal data values and the external data values that were read that are taken into account in calculating coefficient a;
assigning a weight to each data value of the subset of the internal data values and the external data values;
multiplying each data value of the subset of the internal data values and the external data values by its assigned weight, thereby generating a plurality of products; and
adding all of the plurality of products.

15. The method of claim 14, wherein the step of calculating coefficient b further comprises
identifying a subset of the internal data values and the external data values that were read that are taken into account in calculating coefficient b;
assigning a weight to each data value of the subset of the internal data values and the external data values;
multiplying each data value of the subset of the internal data values and the external data values by its assigned weight, thereby generating a plurality of products; and
adding all of the plurality of products.

16. The method of claim 15, wherein the step of calculating P further comprises:
identifying a subset of the internal data values and the external data values that were read that are taken into account in calculating P;
assigning a weight to each data value of the subset of the internal data values and the external data values;
multiplying each data value of the subset of the internal data values and the external data values by its assigned weight, thereby generating a plurality of products; and
adding all of the plurality of products.

17. The method of claim 16, further comprising:
receiving, by the company, a tax credit proportional to Total_{c} and proportional to Rₘ.

18. The method of claim 17, further comprising:
deducting, by the company, less than or equal to 35% of unrecovered costs associated with said commercial space from a corporate tax associated with the company.

19. The method of claim 18, wherein the educational services comprise daycare and/or preschool through eighth grade instruction.
